(19) United States
(12) Patent Application Publication
(10) Pub. No.: US 2025/0189450 A1
(43) Pub. Date: Jun. 12, 2025

(54) MICROPLATE READER

(71) Applicant: Molecular Devices, LLC, San Jose, CA (US)

(72) Inventors: Zhiqiang ZHANG, Shanghai (CN); Tao BAI, Shanghai (CN); Bingxing YAO, Shanghai (CN); Jieying ZHU, Liaoning (CN); Yeqi LAO, Shanghai (CN)

(21) Appl. No.: 18/727,984

(22) PCT Filed: Dec. 24, 2021
(86) PCT No.: PCT/CN2021/141199

§ 371 Date: Jul. 10, 2024

(51) Int. Cl. G01N 21/64; B01L 9/00

(52) U.S. Cl. CPC G01N 21/6452; B01L 9/523; B01L 2200/025; B01L 2300/0654; B01L 2300/0663; B01L 2300/0681; B01L 2300/0829; G01N 2021/6471; G01N 2201/061

(57) ABSTRACT

A microreader includes: a sample holder (140) configured to support one or more samples to be analyzed; at least two xenon lamps (212) as light sources; at least two optical assemblies (132), each having one or more optical elements (720), the sample holder and each of the optical assemblies (132) being configured to direct the light from the respective xenon lamp (212) to the one or more samples to be analyzed; and detectors, each configured to receive light from the one or more samples supported by the sample holder and generate a signal responsive to the received light from the one or more samples. At least one optical element (720) of at least one of two optical assemblies (132) is configured to be removably retained in the respective optical assembly (132). The removably retained optical element (720) is retained by an assembly of magnets arranged to bias the retained optical element (720) in three-dimensions toward a reference point.

### BACKGROUND

Microplate readers are used to measure chemical, biological, biochemical or physical properties or reactions of samples located in the wells in the microplate. A microplate reader detects light signals light signals produced by, converted by, or transmitted through the samples. The detected signals are analyzed to ascertain properties or identities of the samples. Various detection modes, such as fluorescence, absorption, and luminescence, can be employed by microreaders. The detected signals are analyzed to ascertain properties or identities of the samples. Efforts are ongoing in developing efficient and versatile microreaders.

### SUMMARY

In some embodiments, an analytical apparatus, such as a microreader includes: a sample holder configured to support one or more samples to be analyzed; at least two xenon lamps as light sources; at least two optical assemblies, each having one or more optical elements, the sample holder and each of the optical assemblies being configured to direct the light from the respective xenon lamp to the one or more samples to be analyzed; and detectors, each configured to receive light from the one or more samples supported by the sample holder and generate a signal responsive to the received light from the one or more samples.

In some embodiments, an analytical apparatus includes: a sample holder configured to support one or more samples to be analyzed; a light source; a first optical subassembly including one or more optical elements; a detector configured to receive light from the one or more samples supported by the sample holder and generate a signal responsive to the received light from the one or more samples; an optical assembly support, the first optical subassembly being mounted on the optical assembly support; and a housing enclosing the sample holder, the light source, the optical assembly support, the first optical subassembly, and the detector, and defining an opening, the optical assembly support being configured to removably hold a second optical subassembly in a retained position, wherein the opening defined in the housing is configured to permit the second optical subassembly to be placed into, and retrieved from, the retained position through the opening, the first optical subassembly and the sample holder being configured to cooperate with the second optical subassembly to direct the light from the light source to the one or more samples to be analyzed.

In some embodiments, an analytical apparatus includes: a sample holder configured to support one or more samples to be analyzed; at least two light sources; at least two optical assemblies, each including one or more optical elements, the sample holder and each of the optical assemblies being configured to direct the light from the respective one of the light sources to the one or more samples to be analyzed; and detectors, each configured to receive light from the one or more samples supported by the sample holder and generate a signal responsive to the received light from the one or more samples, at least one of the one or more optical elements from a first one of the optical assemblies and at least one of the one or more optical elements from a second one of the optical assemblies forming an optical module removably disposed in the first and second optical assemblies.

In some embodiments, an optical apparatus includes: an optical module including: one or more optical elements; and a first magnetic assembly disposed in a fixed special relationship with the one or more optical elements. The optical apparatus further includes a retainer including: a frame; and a second magnetic assembly affixed to the frame. The first and second magnetic assemblies are configured to cooperatively retain the optical module relative to the frame with zero degrees-of-freedom.

### BRIEF DESCRIPTION OF THE DRAWINGS

FIG. 1 depicts an exterior view of a microplate reader according to some embodiments.

FIG. 2 depicts a microplate reader, showing only certain optical and mechanical components, according to some embodiments.

FIG. 3 depicts the microplate reader depicted in FIG. 2 but viewed from a different perspective, according to some embodiments.

FIG. 4 depicts the microplate reader depicted in FIG. 2 but viewed from a different perspective, according to some embodiments.

FIG. 5 depicts the microplate reader depicted in FIG. 2 but viewed from a different perspective, according to some embodiments.

FIG. 6 depicts the microplate reader depicted in FIG. 2 but viewed from a different perspective, according to some embodiments.

FIG. 7 depicts a removable optical module that is a part of the microplate reader depicted in FIG. 2, according to some embodiments.

FIG. 8 depicts the optical elements inside the optical module depicted in FIG. 7, according to some embodiments.

FIG. 9 depicts the optical module depicted in FIG. 7 (without the handle), showing the locations of the retaining magnets in the optical module, according to some embodiments.

FIG. 10 depicts the optical module depicted in FIG. 7 magnetically retained in a retainer, according to some embodiments.

FIG. 11 depicts a retainer, in the microplate reader depicted in FIG. 2, for retaining the optical module depicted in FIG. 7, according to some embodiments.

FIG. 12 depicts the retainer depicted in FIG. 11 but viewed from a different perspective, according to some embodiments.

FIGS. 13A, B, and C depict relative positions of the magnets in the optical modules depicted in FIG. 7 and the retainer depicted in FIG. 11, according to some embodiments.

### DETAILED DESCRIPTION

This disclosure relates to microplate readers, which are used to measure chemical, biological, biochemical or physical properties or reactions of samples located in the wells in the microplate. A microplate reader detects light signals light signals produced by, converted by, or transmitted through the samples. The detected signals are analyzed to ascertain properties or identities of the samples. Various detection modes, such as fluorescence, absorption, and luminescence, can be employed by microreaders. The detected signals are analyzed to ascertain properties or identities of the samples.

Microplate readers are often used to analyze large numbers of samples, placed in wells of a sample holder (microplate). Given the number of samples to be analyzed and number of tests of different detection modes that can potentially be performed on each sample, it is advantageous to include components for different detection modes in the same microplate reader. Certain examples disclosed in this disclosure provide a microplate reader with multiple detection modes, with robust, flexible, and economical configurations of various components.

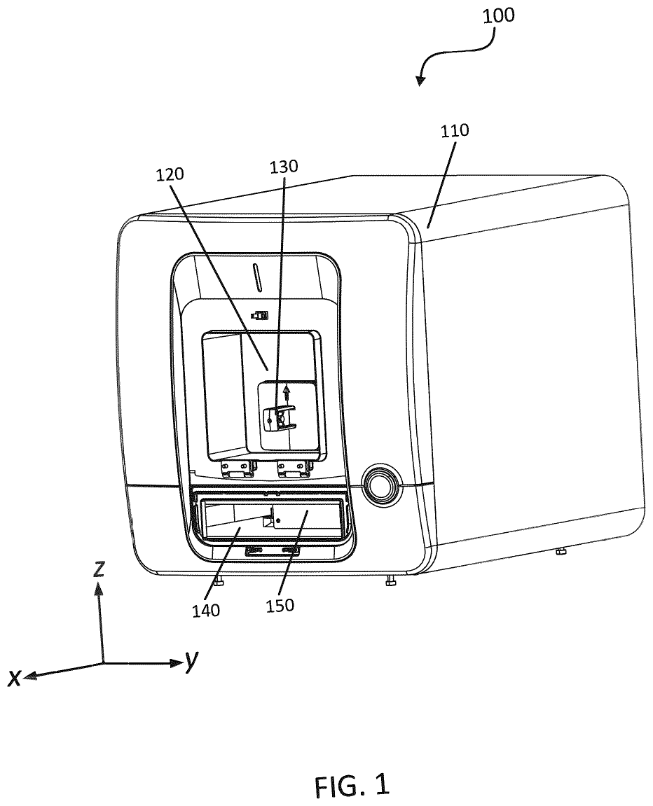

In some embodiments, such as the example shown in FIG. 1, a microplate reader 100 includes a housing 110, which encloses the various optical, mechanical, and electrical components of the microplate reader. The housing 110 in this example includes an optical module port 120, through which an optical module 130 (to be described in detail below) can be inserted into, and are retrieved from, a retainer inside the house 110. The housing 110 in this example further includes microplate port 140 through which a motorized microplate tray 150 can travel in and out of the housing 110. A microplate can be loaded onto the microplate tray 150 outside the housing and be transported to inside the housing 110 for the samples contained in the wells of the microplate to be analyzed by the micro plate reader 100.

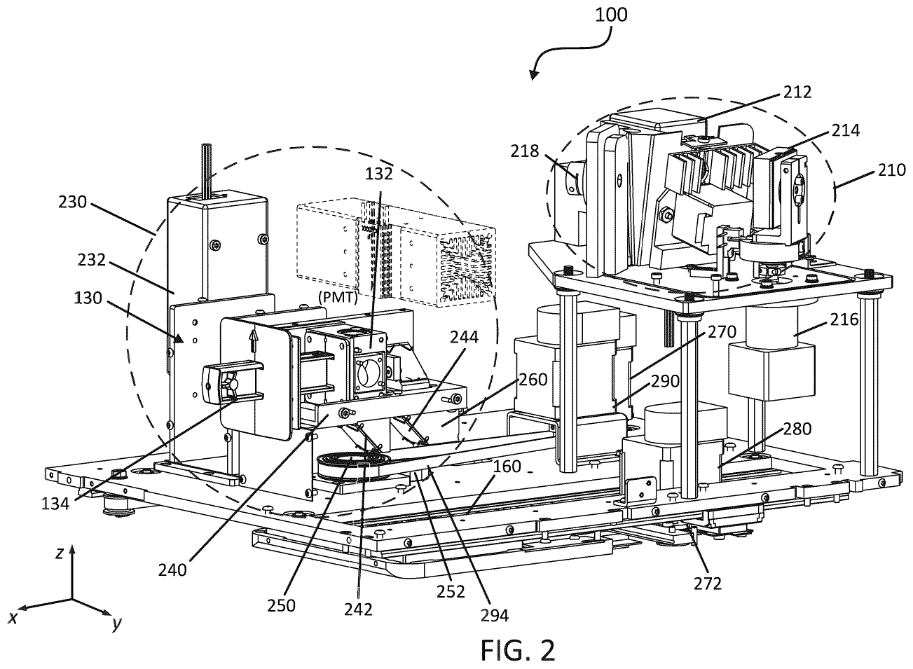

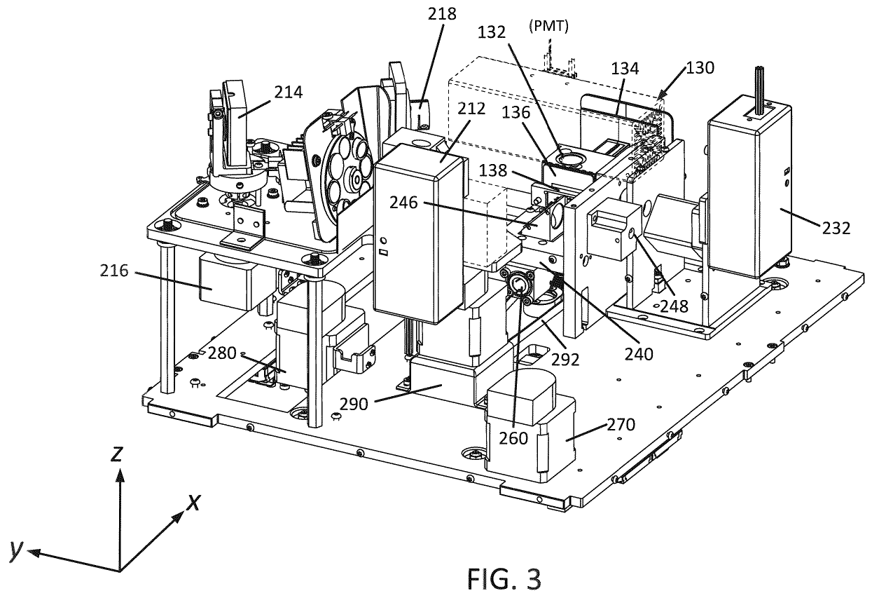

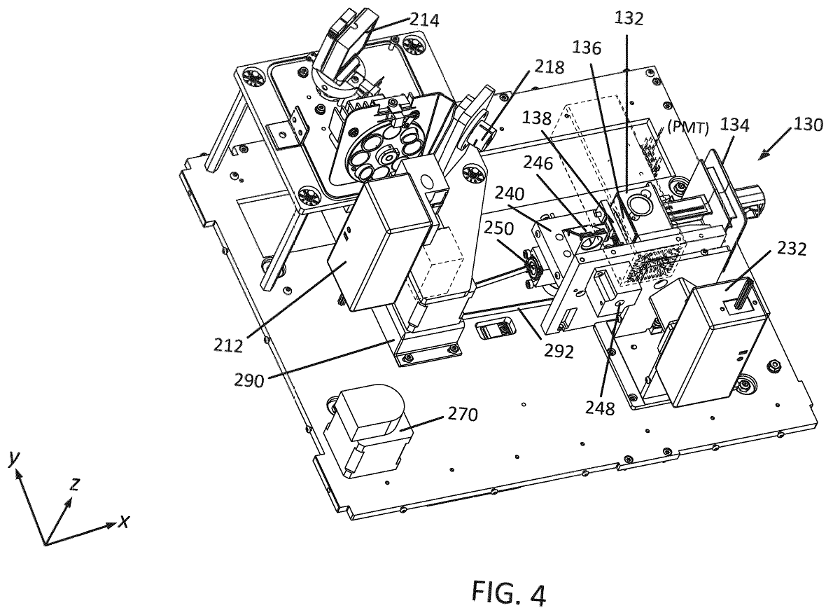

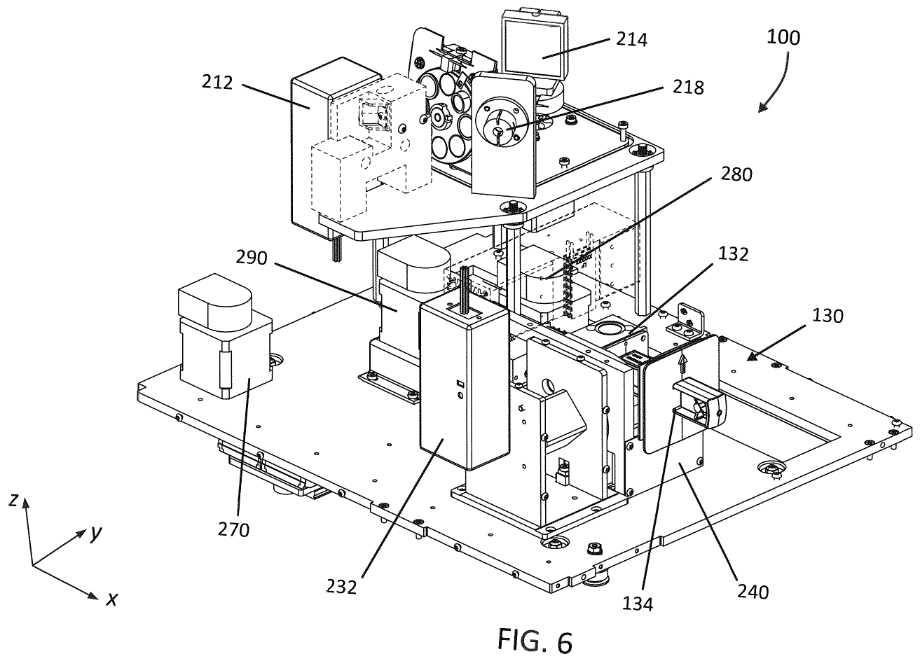

In some embodiments, as in the example shown in FIGS. 2-6, the microliter 100 further includes a first optical subsystem 210, which includes a first light source 212, which in this example is a xenon lamp 212. The first optical subsystem 210 further includes an optical grating 214, which can be rotated along the vertical axis (z-axis). The first optical subsystem 210 further includes an optical fiber assembly, including a first optical fiber holder 218. Light from the first xenon lamp 212 is collimated, attenuated, and filtered and directed to the optical grating 214, which selects light of a narrow wavelength range and directs the selected light into the optical fiber assembly at one end at the first optical fiber holder 218. The optical fiber (not shown in the drawings) transmits the light to the other end at a second optical fiber holder 248 (see FIGS. 3 and 4). The light transmitted through the optical fiber is reflected by the mirror 246 down to the samples held in the microplate 160 through the quartz plate 244 and second lens 252, which focuses the light on to the samples, for absorption analysis. The quartz plate 244 reflects a small portion (e.g., about 10%) of the light from the mirror 246 into a light detector 260, which measures the incoming light and provides a reference signal for absorption analysis.

The microplate reader 100 in this example further includes a second optical subsystem 230, which includes a second light source 232, which in this example is another xenon lamp. The second optical subsystem 230 further includes a stationary retaining block 240, and various optical components, including quartz plates 242, 244, and mirror 246 mounted on the retaining block 240. The second optical subsystem 230 further includes the optical module 130, which includes an optical assembly 132 and a handle 134 attached to the optical assembly 132 to facilitate the insertion of the optical assembly 132 into, and retrieval of the optical assembly 132 from, the microplate reader 100. As described in more detail below, the optical assembly 132 in this example is retained, with no degree of freedom, by the retaining block 240 by two sets of magnets when the optical assembly 132 is placed in the retaining block 240. The optical assembly 132, when retained by the retaining block 240, is positioned directly above the quartz plate 242.

The optical subsystem 230 in this example further includes a first lens 250 and a second lens 252. The first lens 250 is located directly below (along z-axis) quartz plate 242 and the inserted optical assembly 132; the seven lens 252 is located directly below quartz plate 244. The optical subsystem 230 further includes an optical detector, which in this example is a photomultiplier tube (PMT) (labeled but not depicted in the drawings), positioned directly above the inserted optical assembly 132.

Light from the second xenon lamp 232 is collimated, attenuate, and filtered and directed to the optical assembly 132, which, in certain settings, such as those for fluorescence analyses, reflects (with a dichroic mirror, as described in more detail below) a portion (wavelength-wise) of the received light through quartz plate 242 into the first lens 250, which focuses the light onto the sample below for fluorescence analysis. Light from below the first lens 250 (e.g., fluorescent or luminescent light from a sample position below the first lens 250) passes through the quartz plates 242 and optical assembly 132 and into the PMT, which converts the received optical signals into corresponding electrical signals, which are processed by the electronics (not shown in drawings) associated with the PMT for analysis.

A small portion (e.g., about 10%) of the light reflected by downwardly by the optical assembly 132 is reflected by the quartz plate 242 toward the quartz plate 244, which transmits a large portion (e.g., about 90%) of the light into the light detector 260, which measures the incoming light and provides a reference signal for fluorescence analysis.

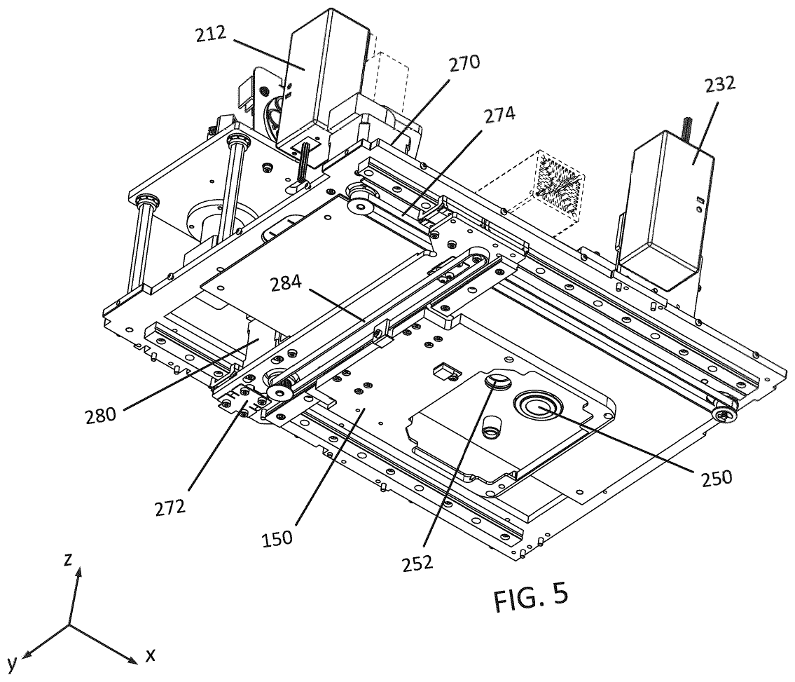

The microplate reader 100 in this example further includes a first motor 270 for driving a carrier 272 along the x-axis. The first motor 270 is mounted at a fixed location in the microplate reader 100. The microplate reader 100 in this example further includes a second motor 280 mounted on the carrier 272 for driving the microplate tray 150 along the y-axis. As shown in FIG. 5, the carrier 272 is driven by the first motor 270 through a belt 274; and the microplate tray 150 is driven by the second motor 280 through a belt 284. Collectively, the first motor 270 and the second motor 280 move the microplate tray 150 in the x-y plane to position each sample in a microplate held by the microplate trailer 150 at a desired location, such as under the first lens 250 or second lens 252.

The microplate reader 100 in this example further includes an optical detector and associated electronics (not shown in the drawings) mounted on the microplate tray 150 and below the microplate 160 for measuring light transmitted through the samples in the absorption detection mode.

The microplate reader 100 in this example further includes (see, for example, FIG. 2) a motor 290 for driving, through a belt 294, a focusing mechanism for the first lens 250 to focus the light from the optical assembly 132 onto the samples held in the microplate 160.

The microplate reader 100 in the examples described above includes separate light sources, each with its dedicated optical components (filters, mirrors, etc.) for transmitting light from the source to the sample. Having dedicated optical components for each light source has the advantage of simple, robust configurations for different detection modes, such as fluorescence and absorbance, as compared to certain traditional microplate readers that employ movable optical components for changing optical paths for different detection modes using a single light source. Additionally, both light sources in the examples described above are xenon lamps, which operate at lower temperatures than certain other types of light sources, such as halogen lamps, used in certain traditional microplate readers.

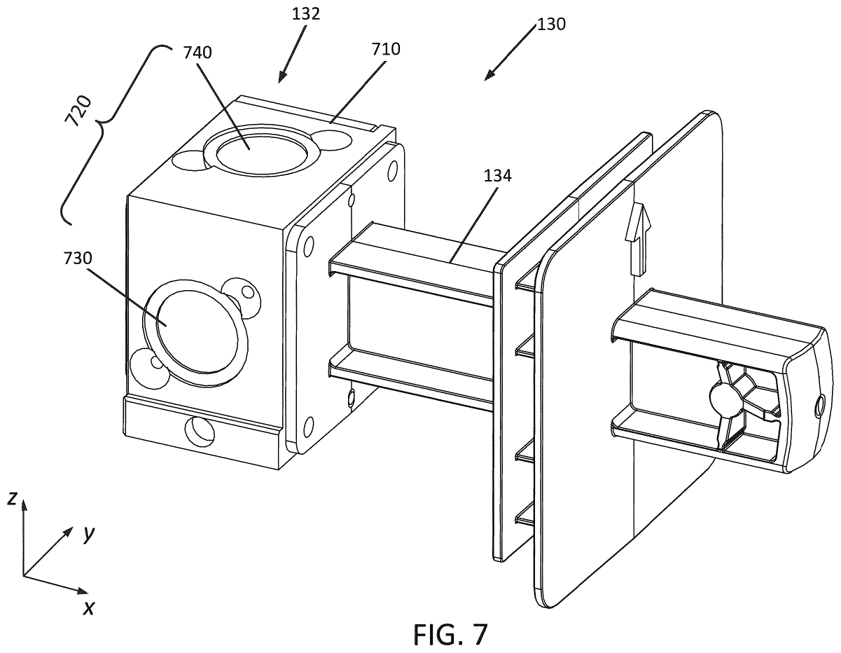

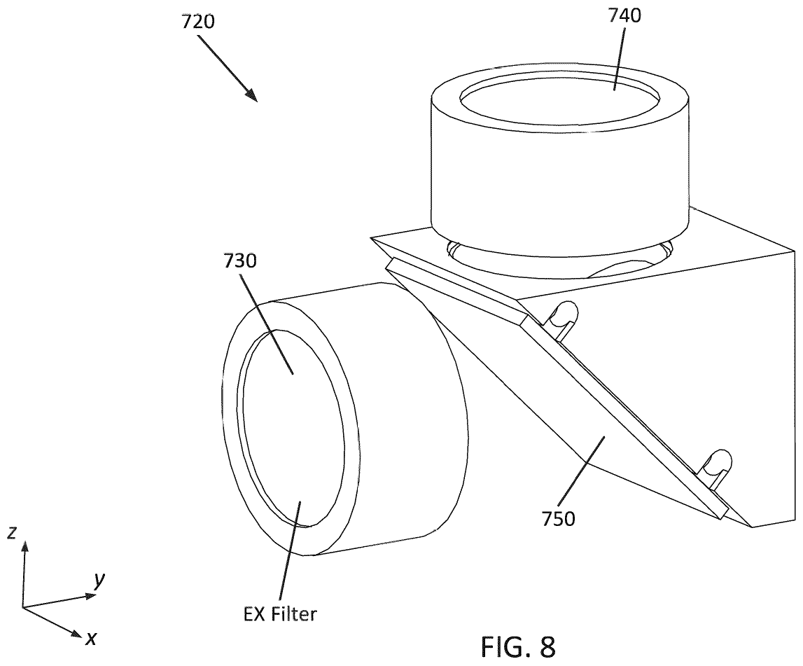

As described above, in certain embodiments, the microplate reader 100 includes an optical module 130 that is removably (detachably) installed in the microplate reader, more specifically, in the second optical subassembly 230. An example of such an optical module is shown in FIGS. 7-9. The optical module 130 shown in FIG. 7 includes an optical assembly 132 and a handle 134 attached to the optical assembly 132 for inserting the optical assembly 132 into a retained position in the optical subassembly 230 through the opening 120 in the house 110 of the microplate reader 100 (see FIG. 1) and retrieving the optical assembly 132 from the retained position. The optical assembly 132 in this example includes a frame 710 and optical elements 720 mounted to the frame 710. The optical elements 720 in this example includes an excitation light filter 730, with an optical axis aligned with the y-axis, and an emission light filter 740, with an optical axis aligned with the z-axis when the optical assembly 132 is properly retained in the optical subassembly 230. The optical elements 720 in this example further includes (see FIG. 8) a dichroic mirror 750 oriented intermediate (e.g., 45°) the y-axis and the z-axis. In operation, the excitation light filter 730 receives light (excitation light) originated from the second light source 232 and filters and passes the received light to the dichroic mirror 750, which in some embodiments is a long-pass mirror reflects the excitation light, which has wavelengths smaller than a chosen threshold value (cut-on wavelength), down (along the z-axis) toward the first lens 250. Light from the samples under the first lens 250 travels upward (along the z-axis) to the optical assembly 132. In settings, such as those for fluorescence analyses, the light (e.g., fluorescent light) from the samples has longer wavelengths than the excitation light reaches the dichroic mirror 750. In some embodiments, the cut-on wavelength of the dichroic mirror 750 is chosen such that the dichroic mirror 750 passes the light from the samples to the mission light filter 740, which filters and transmits the light to the PMT for analysis.

In some embodiments, for example for luminescence analyses, the optical assembly 132 does not include any dichroic mirror or the excitation light filter, but only a clean-up filter 740, which filters out light of certain wavelengths (e.g., 675 nm or longer). In such settings, luminescent light from the samples is filtered by the clean-up filter 740 and detected by the PMT.

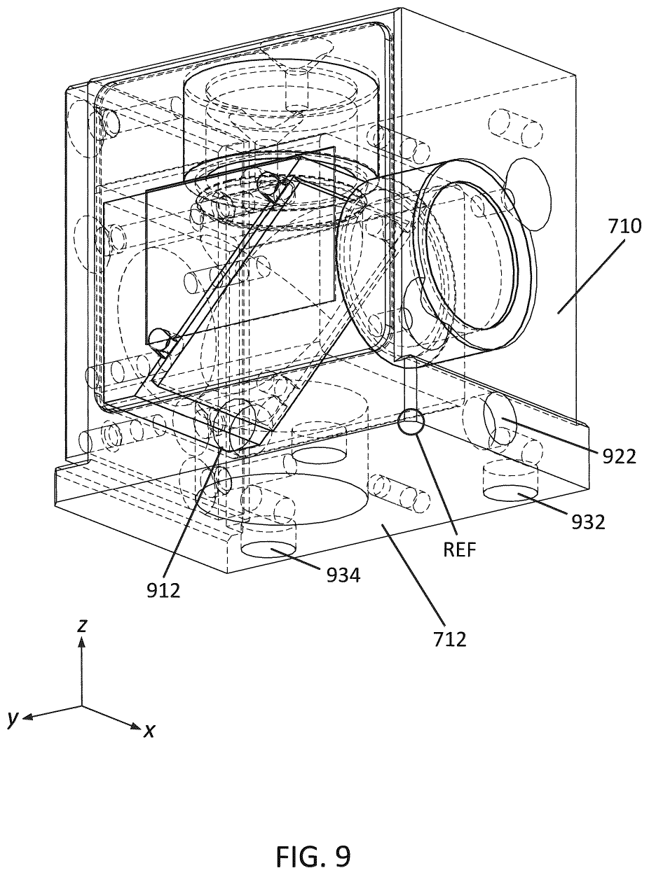

In certain embodiments, as shown in FIG. 9, the frame 710 of the optical assembly 132 includes a portion (the bottom portion in this example) 712 that includes, or has affixed therein, magnets 912, 922, 932, 934, 936. In this example, a first magnet 912 is located in the rear portion of the frame 710 and polarized along the x-axis; a second magnet 922 is located in the left (when viewed from the front end of the microplate reader 100) portion of the frame 710 and polarized along the y-axis; and the remaining magnets 932, 934, 936 are located in the bottom portion of the frame 710 and polarized along the Z axis.

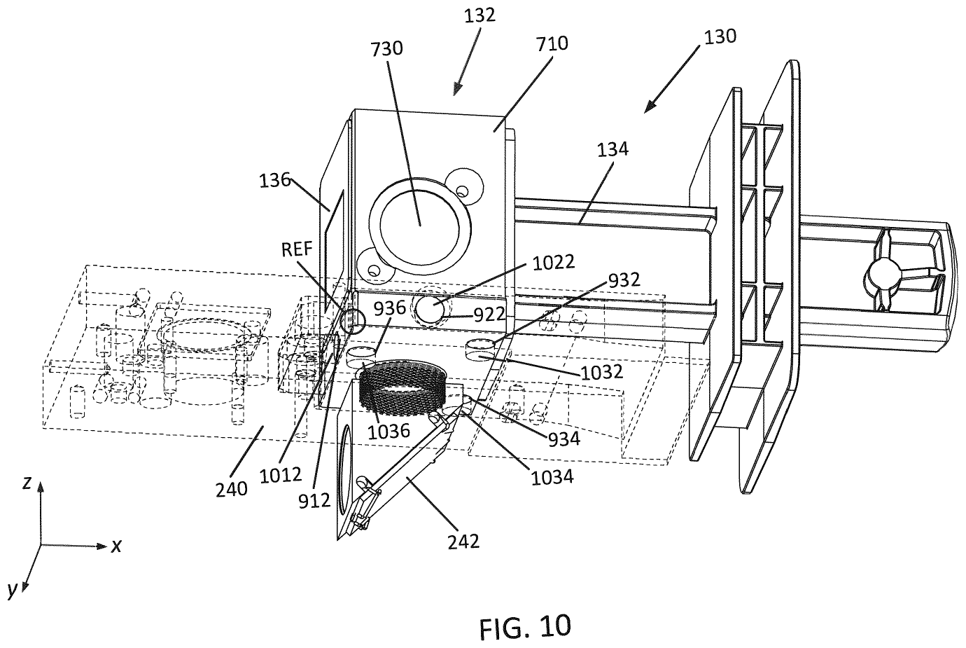

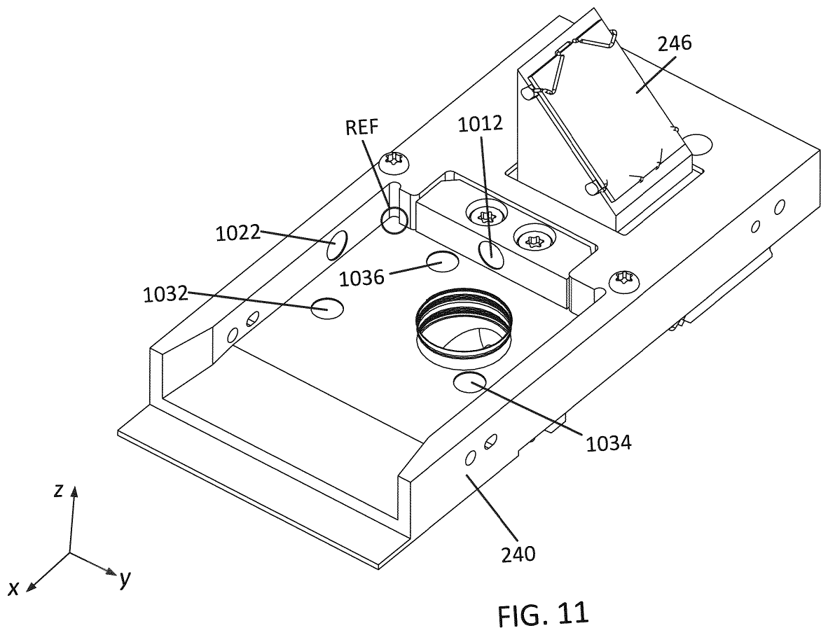

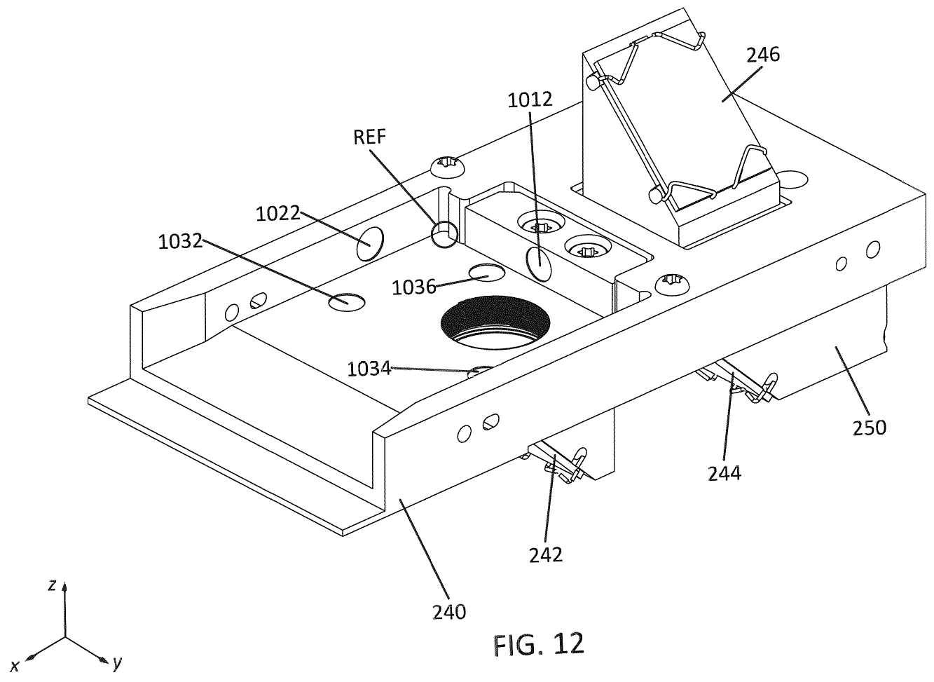

Corresponding to the arrangements of the magnets 912, 922, 932, 934, 936 in the frame 710 of the optical assembly 132, as shown in FIGS. 10, 11, and 12, the retaining block 240 includes, or has affixed therein, five magnets 1012, 1022, 1032, 1034, 1036, each positioned in proximity to, and polarized in the same direction as, a respective one of the magnets 912, 922, 932, 934, 936 in the frame 710, when the optical assembly 132 is placed in the retained position. Thus, the attractive magnetic forces between the pairs of magnets in the optical assembly 132 and the retaining block 240 keep the optical assembly 132 retained to the retaining block 240.

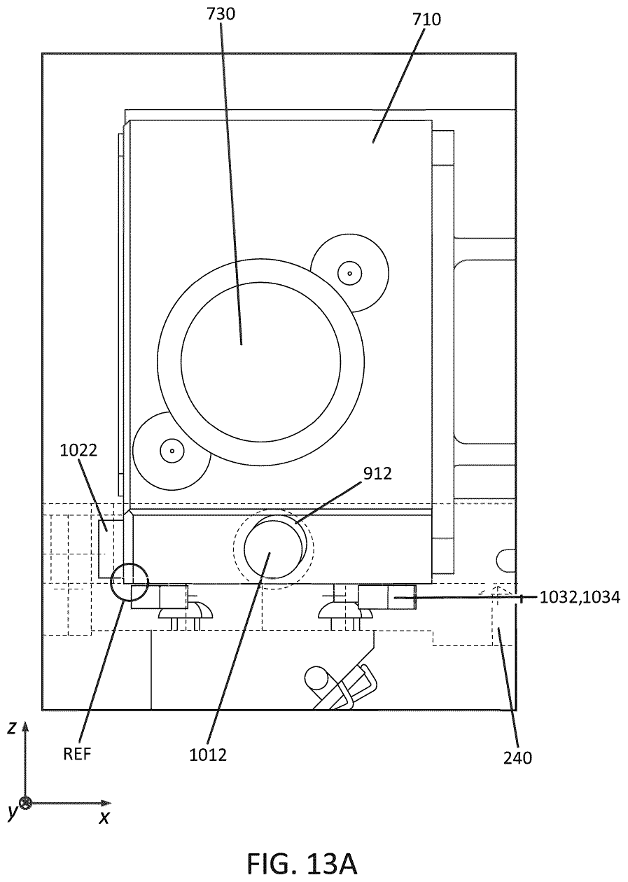

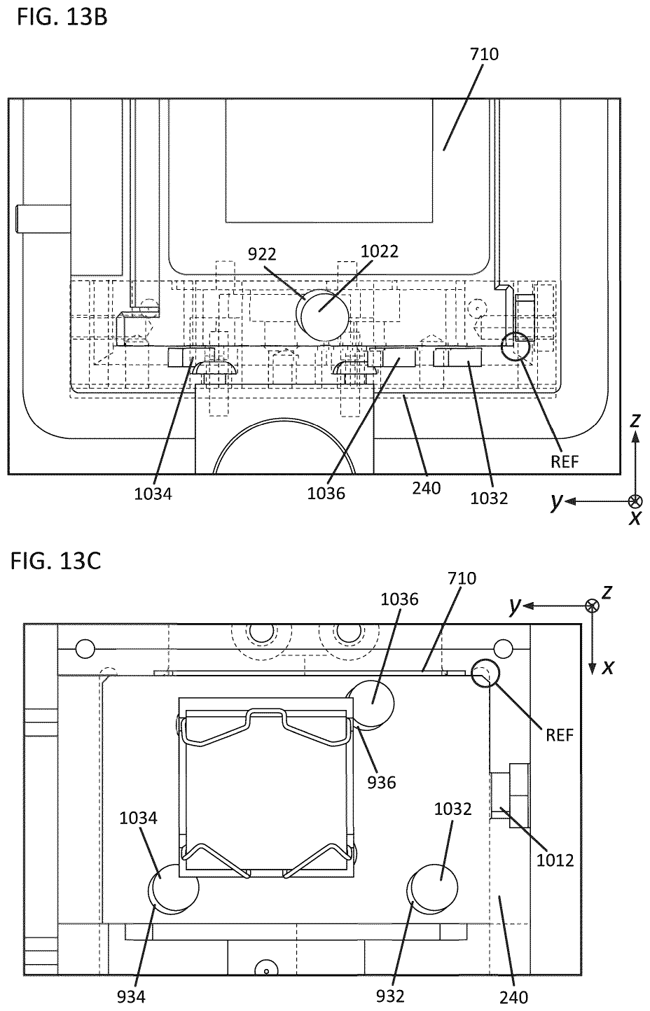

Moreover, each magnet 1012, 1022, 1032, 1034, 1036 in the retaining block 240 is slightly offset in a direction transverse to the polarization direction from the corresponding magnet 912, 922, 932, 934, 936 in the optical assembly 132, such that the net magnetic force between the retaining block 240 and optical assembly 132 biases the optical assembly toward a reference point (“REF”), which is a corner in the retaining block 240. As shown in FIG. 13A, the first magnet 1012 in the retaining block 240 is nearly completely aligned with the first magnet 912 in the optical assembly 132 but slightly offset from the magnet 912 in the minus x-direction and minus z-direction; similarly, as shown in FIG. 13B, the second magnet 1022 in the retaining block 240 is nearly completely aligned with the first magnet 922 in the optical assembly 132 but slightly offset from the magnet 922 in the minus y-direction and minus z-direction; likewise, as shown in FIG. 13C, the three magnets 1032, 1034, 1036 in the retaining block 240 are nearly completely aligned with the respective magnets 932, 934, 936 in the optical assembly 132 but slightly offset from the respective magnets 932, 934, 936 in the minus x-direction and minus y-direction. The result is that the optical assembly 132 is biased toward the corner REF in the retaining block 240 when the optical assembly 132 is retained by the reading block 240, with no degree-of-freedom absent a force above a threshold level pulling the optical assembly 132 from its retained position.

With the configuration of the magnets in the optical assembly 132 and retaining block 240, the optical assembly 132 can be conveniently inserted into, and be secured with precision in, its retained position, as well as conveniently removed from the microplate reader, for example, for maintenance or replacement by another optical assembly having a different set of optical elements, such as filters of different wavelength ranges. In some embodiments, with the configuration for removably retainable optical module 130, different optical assemblies 132 can be inserted for different applications. For example, optical assemblies 132 with dichroic mirrors 750 of different cut-on wavelengths can be selectively inserted into the microplate reader 100 for fluorescent analyses at different excitation wavelengths; an optical assembly 132 with only hollow ports or only a clean-up filter 740 can be inserted for luminescent analyses.

In some embodiments, as shown in FIGS. 3, 4, and 10, the optical module 130 further includes an identification structure 136 corresponding to certain characteristics of the optical assembly 132. For example, the identification structure 136 can be a near-field communication (NFC) tag that stores information about certain characteristics of the optical assembly 132, including whether the optical assembly 132 is for luminescent analyses or fluorescent analyses or, in the case of fluorescent analyses, the cut-on wavelength (or an identifier associated with the cut-on wavelength) of the dichroic mirror. Correspondingly, the microplate reader 100 includes a reading structure, such as an NFC reader 138 positioned on the retaining block 240, that detects that information provided by the identification structure 136 and generates a signal that is used to configure the electronics and/or software to operate in a manner appropriate for the type of analysis corresponding to the type of optical assembly 132. For example, in some embodiments, if an optical assembly 132 with a dichroic mirror is inserted, the detector 138 will generate a signal to configure the electronics and software of the microplate reader to perform operations appropriate for fluorescent analyses; if an optical assembly 132 without a dichroic mirror is inserted, the detector 138 will generate a signal to configure the electronics and software of the microplate reader to perform operations appropriate for luminescence analyses (for example, the excitation light source 232 would not be turned on). Any combination of structures 136, 138 suitable for identifying an optical assembly 132 properly retained in the microplate reader 100 can be used. For example, matching electrode patterns, optical paths, or mechanical registrations can be used.

In some embodiments, microplates have identification marks or tags on them, and a microplate reader can include, in addition to the components described above for sample analysis, detectors or readers for automated identification of microplates. Examples of identification marks for tags microplates include switches, encoders, barcodes and near-field communication (“NFC”) tags; examples of detectors or readers in microplate readers include barcode readers, NFC readers and associated controllers.

In some embodiments, a microplate reader includes, in addition to components for sample analysis as described above, and automated height detection system for determining the height of a microplate in the microplate reader. In some embodiments such a height detection system includes a light source (e.g., LED) positioned laterally (e.g. in the y-direction) on one side of the micro plate, and a detector, such as a photodiode array, positioned battery on the other side of the microplate. By projecting light from the light source toward the photodiode array, and by determining the profile of the intensities of light received by the photodiodes in the photodiode array, the height (z-position) of the top of the microplate can be determined. Such automated determination of the microplate height makes the sample analysis process more efficient and helps avoid operational errors, such as driving the microplate into collision with other structures in the microplate reader.

With the various example features disclosed above, accurate, robust and versatile microplate readers or, more generally, optical analytical instruments can be made.

This disclosure describes some examples of the present technology with reference to the accompanying drawings, in which only some of the possible examples were shown. Other aspects can, however, be embodied in many different forms and should not be construed as limited to the examples set forth herein. Rather, these examples were provided so that this disclosure was thorough and complete and fully conveyed the scope of the possible examples to those skilled in the art.

Although specific examples were described herein, the scope of the technology is not limited to those specific examples. One skilled in the art will recognize other examples or improvements that are within the scope of the present technology. Therefore, the specific structure, acts, or media are disclosed only as illustrative examples. Examples according to the technology may also combine elements or components of those that are disclosed in general but not expressly exemplified in combination, unless otherwise stated herein. The scope of the technology is defined by the following claims and any equivalents therein.

1. An analytical apparatus, comprising:
a sample holder configured to support one or more samples to be analyzed;
a plurality of lamps;
a plurality of optical assemblies, each comprising one or more optical elements, the sample holder and each of the plurality of optical assemblies are arranged to direct the light from the respective one of the plurality of lamps to the one or more samples to be analyzed;
a support, wherein at least a portion of each of the plurality of optical assemblies is mounted on the support;
a plurality of detectors, each arranged to receive light from the one or more samples supported by the sample holder and generate a signal responsive to the received light from the one or more samples; and
a first magnetic assembly affixed to the support, the first magnetic assembly comprising at least three magnets polarized in directions mutually transverse to one another,
wherein the support defines a reference point, and wherein the first magnetic assembly is configured to exert a force on the optical module toward the reference point when the optical module is retained relative to the support.

2. The analytical apparatus of claim 1, wherein the sample holder comprises a motorized stage movable in three dimensions and configured to support a plate having a plurality of wells defined in the plate for containing respective samples to be analyzed.

3. The analytical apparatus of claim 1, further comprising
an optical module frame, wherein at least one of the one or more optical elements from a first one of the plurality of optical assemblies and at least one of the one or more optical elements from a second one of the plurality of optical assemblies are mounted on the optical module frame, forming an optical module with the optical module frame, the optical module being removably retainable relative to the support.

4. The analytical apparatus of claim 3, wherein the optical module further comprises a second magnetic assembly, the first and second magnetic assemblies being configured to cooperatively retain the optical module relative to the support with zero degrees-of-freedom.

5. The analytical apparatus of claim 4, wherein:
the first magnetic assembly comprises at least three magnets polarized in directions mutually transverse to one another; and
the second magnetic assembly comprises at least three magnets polarized in directions mutually transverse to one another,
each of the at least three magnets in the first magnetic assembly being positionable in proximity to, and polarized in the same direction as, and thereby in a pairing relationship with, a respective one of the at least three magnets in the second magnetic assembly.

6. (canceled)

7. The analytical apparatus of claim 1, wherein the magnets in each pairing relationship when the optical module is retained relative to the support are positioned offset from each other in a direction transverse to their direction of polarization and toward the reference point.

8. The analytical apparatus of claim 1, wherein:
a first one of the plurality of optical assemblies is configured to transmit the light from a first one of the plurality of lamps to at least one of the samples from a first direction, and a first one of the plurality of detectors is configured to receive the light transmitted to, and through, the at least one of the samples; and
a second one of the plurality of optical assemblies is configured to transmit the light from a second one of the plurality of lamps to the at least one of the samples from a second direction to produce a luminescent light from the at least one of the samples, and a second one of the plurality of detectors is configured to receive the luminescent light from the at least one of the samples.

9. The analytical apparatus of claim 3, where the at least one of the one or more optical elements from the first one of the plurality of optical assemblies and the at least one of the one or more optical elements from the second one of the plurality of optical assemblies are optical filters of different wavelengths.

10. The analytical apparatus of claim 1, wherein the optical module further comprises a dichroic mirror configured to split a light beam into light beams of first wavelength and a second wavelength that is different from the first wavelength and direct the light beam of the first wavelength to the first one of the optical filters, and direct the light beam of the second wavelength to the second one of the optical filters.

11. An analytical apparatus, comprising:
a sample holder configured to support one or more samples to be analyzed;
a light source;
a first optical subassembly comprising one or more optical elements;
a detector configured to receive light from the one or more samples supported by the sample holder and generate a signal responsive to the received light from the one or more samples;
an optical assembly support, the first optical subassembly being mounted on the optical assembly support; and
a housing enclosing the sample holder, the light source, the optical assembly support, the first optical subassembly, and the detector, and defining an opening,
the optical assembly support being configured to removably hold a second optical subassembly in a retained position, wherein the opening defined in the housing is configured to permit the second optical subassembly to be placed into, and retried from, the retained position through the opening, and wherein the optical assembly support defines a reference point;
the first optical subassembly and the sample holder being configured to cooperate with the second optical subassembly to direct the light from the light source to the one or more samples to be analyzed; and
a first magnetic assembly affixed to the optical assembly support, the first magnetic assembly comprising at least three magnets polarized in directions mutually transverse to one another and arranged to exert a force on the optical module toward the reference point when the optical module is retained relative to the support.

12. The analytical apparatus of claim 11, further comprising
a second magnetic assembly, the first magnetic assembly affixed to the second optical subassembly to hold the second optical subassembly in the retained position with zero degrees-of-freedom.

13. The analytical apparatus of claim 12, wherein
each of the at least three magnets in the first magnetic assembly is disposed in proximity to, and polarized in the same direction as, and thereby paired with, a respective one of at least three magnets in the second magnetic assembly when the second optical subassembly is held in the retained position.

14. The analytical apparatus of claim 13, wherein:
the support defines a reference point; and
the first magnetic assembly is configured to cooperate with the second magnetic assembly to exert a force on the second optical subassembly toward the reference point when the second optical subassembly is held in the retained position.

15. The analytical apparatus of claim 14, wherein each of the at least three magnets in the first magnetic assembly is positioned to be offset from the respective paired magnet in the second magnetic assembly in a direction transverse to the direction of polarization of the pair of magnets and toward the reference point.

16. An analytical apparatus, comprising:
a sample holder configured to support one or more samples to be analyzed;
a plurality of light sources;
a plurality of optical assemblies, each comprising one or more optical elements, the sample holder and each of the plurality of optical assemblies being configured to direct the light from the respective one of the plurality of light sources to the one or more samples to be analyzed; and
a support, wherein at least a portion of each of the plurality of optical assemblies is mounted on the support,
a plurality of detectors, each arranged to receive light from the one or more samples supported by the sample holder and generate a signal responsive to the received light from the one or more samples; and
a first magnetic assembly affixed to the support, the first magnetic assembly comprising at least three magnets polarized in directions mutually transverse to one another,
wherein the support defines a reference point, and wherein the first magnetic assembly is configured to exert a force on the optical module toward the reference point when the optical module is retained relative to the support,
and wherein at least one of the one or more optical elements from a first one of the plurality of optical assemblies and at least one of the one or more optical elements from a second one of the plurality of optical assemblies forms an optical module removably disposed in the first and second pluralities of optical assemblies.

17. The analytical apparatus of claim 16, wherein the sample holder comprises a motorized stage movable in three dimensions and configured to support a plate having a plurality of wells defined in the plate for containing respective samples to be analyzed.

18. The analytical apparatus of claim 16, wherein:
a first one of the plurality of optical assemblies is configured to transmit the light from a first one of the plurality of light sources to at least one of the samples from a first direction, and a first one of the plurality of detectors is configured to receive the light transmitted to, and through, the at least one of the samples; and
a second one of the plurality of optical assemblies is configured to transmit the light from a second one of the plurality of light sources to the at least one of the samples from a second direction to produce a luminescent light from the at least one of the samples, and a second one of the plurality of detectors is configured to receive the produced luminescent light from the at least one of the samples.

19. The analytical apparatus of claim 18, wherein the optical module further comprises a dichroic mirror configured to split a light beam into light beams of two different wavelengths, and direct the light beam of the first wavelength to the at least one of the optical elements from the first one of the plurality of optical assemblies, and direct the light beam of the second wavelength to the at least one of the one or more optical elements from the second one of the plurality of optical assemblies optical filters.

20-24. (canceled)

25. The analytical apparatus of claim 1, wherein each of the plurality of lamps is a xenon lamp.
